(19) United States
(12) Patent Application Publication
(10) Pub. No.: US 2003/0193884 A1
(43) Pub. Date: Oct. 16, 2003

(54) Optical disk storage media identification

(76) Inventor: James K. Louie, Colorado Springs, CO (US)

Correspondence Address: Steven C. Lieske, Oppenheimer Wolff & Donnelly LLP, Suite 3300, 45 South Seventh Street, Minneapolis, MN, 55402, US

(21) Appl. No.: 10/123,812

(22) Filed: Apr. 16, 2002

(51) Int. Cl. G11B 23/03

(52) U.S. Cl. 369/291

(57) ABSTRACT

A optical disk cartridge for a new generation of optical disk storage technology. Notches are formed in the front-edge corners of the cartridge to identify the cartridge as containing an optical disk of a new generation. When a notched cartridge is inserted into a previous generation disk unit, the notches prevent the full-insert detection switch from activating, thus preventing the disk from spinning-up and being accessed. An optical disk drive unit is also provided, in which the full-insert detection switches are repositioned as to not be in vicinity to the notches of the optical disk cartridge. Thus, the optical disk drive unit of the new generation variety will spin-up disks in cartridges have notches as well as older cartridges without notches, providing backward compatibility.

### BACKGROUND OF THE INVENTION

This invention relates generally to optical disk storage. Particularly, this invention relates to a system that provides identification of optical disk storage media inserted into an optical disk drive for differentiation among different versions of optical storage technology.

In Oct. 2000, a study released out of the University of California, Berkeley reported that it took the entire history of humankind until the year 1999 to accumulate 12 exabytes of information (where 1 exabyte equals 1,000,000,000,000,000,000 bytes). Twelve exabytes of data is 50,000 times the size of the Library of Congress. The study estimated that this amount of accumulated information will double by the middle of the year 2002. The incredible recent growth in the production of information has made the demand for information management tremendous.

Over the course of computing history, various methods of information storage have been used. Currently, optical disk storage is particularly popular, both because it is a removable storage means (in contrast to hard disk drives) and because it offers high capacity at a reasonable cost. Of course, as with many industries, competition is focused on three factors: bigger, faster, and cheaper. With respect to “bigger,” optical disk manufacturers strive to provide higher capacity disks. Currently, an everyday CD-ROM or CD-RW can store about 600 megabytes of information while a single-sided DVD traditionally can store 4,700 megabytes (i.e., 4.7 GB). However, the recent arrival of duallayer optical technology was a jump for disk capacity. By writing and reading data encoded on two different depths or layers of the disk, capacity essentially doubled. For example, a dual-layer DVD can store 8,500 megabytes (i.e., 8.5 GB) per side.

With respect to 12-inch optical disk storage, capacity has increased through what can be considered four generations. In the first generation, a single 12-inch optical disk had a capacity of 2 Gbytes (with 1 Gbyte per side). In the second generation of optical storage, capacity increased to 5.6 Gbytes. In the third generation, it increased to 12 Gbytes. Now, fourth generation optical disk drives accommodate optical disks each having a capacity of 30 Gbytes.

Consumers for optical disk drives demand backward capability. Thus, a fourth generation optical disk drive must not only be able to access data stored on the optical disks using fourth generation technology (enabling up to 30 Gbytes of capacity), but the disk drive must also be able to access data stored using the techniques from the previous generation. This allows the consumer to upgrade to a new optical disk drive unit by replacing an older unit rather than requiring the consumer to maintain a host of older disk drives to access the older optical disks.

Due to the backward compatibility requirement, optical disks and the cartridges that house them have nearly the same physical characteristics from one generation to the next. Various methods have been employed in the prior art when dealing with various generations of technology. FIG. 1 shows a configuration of a cartridge 100 housing of an optical disk drive 105 in which a colored insert 110 is employed to indicate the type of optical storage media within the cartridge 100. For example, a red insert 110 may be used for first generation disks while a blue insert 110 is used for third generation disks.

While the use of such color does indeed provide a way to quickly identify the type of media within the cartridge 100 using visual clues, it therefore must also rely on a human operator to ensure that red cartridges are only placed in first generation disk drive units while blue cartridges are only placed in third generation disk drive units. Obviously, the potential for human error is present in such a methodology.

A second method for distinguishing the various types of optical disks is to perform a ordered strategy of accessing data from the disk. For example, when a optical disk cartridge is inserted in a drive unit, the drive unit may use a first method to access the disk to determine if the disk is of the first-generation variety. If this method fails, the drive unit then uses a second method to access the disk to determine if the disk is of the second-generation variety, etc. This method has two disadvantages. First, initial access time is delayed as the disk drive unit must go through the ordered list of access strategies. Disks of the generation that is tested later in the sequence may take a noticeable amount of time before they are readied for use.

Second, and more importantly, such a method may damage the optical disk itself. As data density increases, the amount of light power, the size of the focused spot, and the wavelength of light changes. It is possible that the access parameters used in a new generation disk drive may physically harm the media from a prior generation. Thus, if a first generation disk is inserted into perhaps a fifth generation disk drive unit, the optical disk media could be damaged in the process of the drive unit processing an ordered strategy of accessing the data from the media.

What is needed in the art is an optical disk drive unit that can readily identify the type of optical disk media present within a cartridge. In such a new generation of units, the disk drive should detect both previous and new generation media types without requiring physical access to the media itself. Thus, such a disk drive unit would be able to correctly handle all sorts of optical disk media. In such a system, the disk cartridge itself for a new generation should be configured so that an older generation disk unit will not be able to access (and potentially damage) the media within the new type of cartridge. Furthermore, the optical disk drive unit should be able to identify the type of media whether the cartridge is inserted for accessing Side A or Side B.

### SUMMARY OF THE INVENTION

In one aspect of the present invention, an improved optical disk cartridge and disk drive unit ensure backward compatibility without allowing an older drive unit to access the media within the improved disk cartridge. The improved optical disk cartridge has a housing containing an optical disk. The housing includes two notches on the leading edge of the cartridge. The improved disk drive unit includes at least one full-insert detection switch to indicate when a cartridge is correctly inserted into the drive unit. Due to the positioning of the notch on the cartridge housing, the full-insert detection switch is actuated by the insertion of either a new generation optical cartridge or one from a previous generation, regardless of whether the cartridges are inserted for accessing Side A or Side B. Due to the placement of the notch in the cartridge, a full-insert detection switch within a disk unit of a previous generation will not activate when a new generation cartridge is inserted. In this way, new generation cartridges cannot be accessed by older generation disk drive units, but new generation drive units can correctly access optical disks from the new or previous generations.

### BRIEF DESCRIPTION OF THE DRAWINGS

FIG. 1 is a view of a prior art cartridge configuration having a colored insert to indicate the type of optical storage media within the cartridge.

FIG. 2 shows a view of a full-insert detection switch from a disk drive unit of the prior art.

FIGS. 3 shows a view of a full-insert detection switch from a new generation disk drive unit of the present invention.

FIG. 4 is a view of a new generation optical disk cartridge having at least one notch in accordance with the present invention.

FIG. 5 is a composite view of the new generation disk cartridge in alignment with the full-insert detection switch from the prior art as well as one in accordance with the present invention.

### DETAILED DESCRIPTION OF THE INVENTION

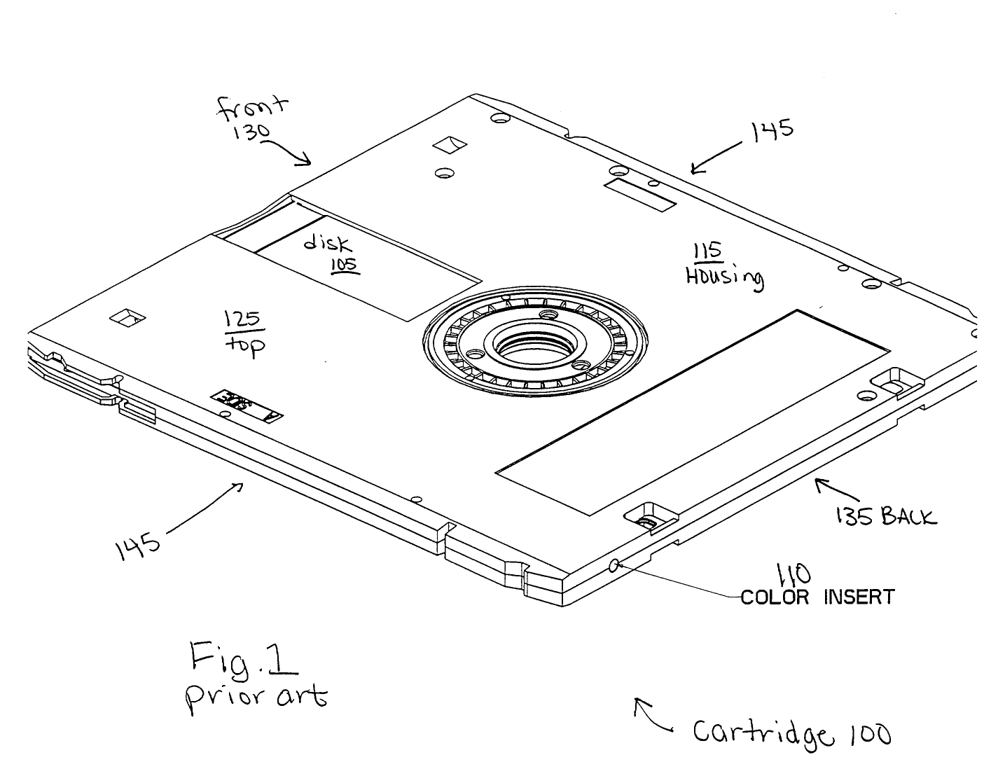

As previously explained, FIG. 1 shows a cartridge 100 for an optical disk from the prior art. While a color insert 110 is included in FIG. 1, it is understood that although many versions of prior art cartridges do not have such a color insert, they otherwise share a similar shape and configuration. As is well known in the art, such cartridges consist of a housing 115 that encapsulates the optical disk 105. The housing 115 is usually made from two pieces of plastic (a base (not shown) and a cover 120) that have been sonically welded or otherwise connected. The housing defines a top face 125, a corresponding bottom face (not shown), a front (not shown, but indicated by arrow 130), a back (not shown, but indicated by arrow 135), a first side (arrow 140) and a second side (arrow 145). Often, the optical disk 105 is recorded with data on both sides of the disk. Therefore, the cartridge 100 can be inserted into a disk drive unit two ways—one way to access data from Side A and another way to access data from Side B.

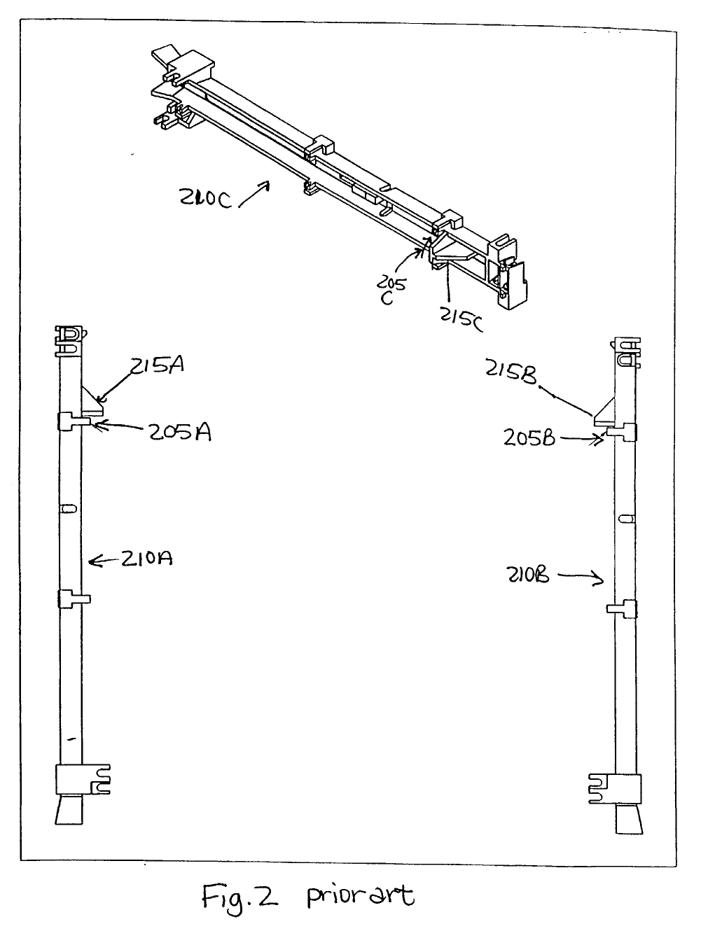

FIG. 2 shows views of full-insert detection switches (also referred to as media identification switches) installed on cartridge holders 210. Usually, two cartridge holders 210A and 210B are installed within a prior art disk drive unit (not shown, but well known in the art) such that as an optical disk cartridge 100 is inserted into the disk drive unit, the left and right cartridge holders 210A and 210B guide and support the cartridge. There are guide-stops 215 or similar devices in place to give a user tactile feedback that the cartridge is fully inserted—and to prevent the cartridge from being inserted too far into the drive unit. When the cartridge is fully inserted into the disk drive unit, the full-insert detection switches 205 are activated by the presence of the front-most portion of the cartridge sides 140 and 145 near the full-insert detection switch. While the switches can be mechanical switches, often such switches operate electronically without moving parts, such as with the use of a light sensor. Only when the full-insert detection switch is activated does the disk drive unit spin-up the optical disk 105.

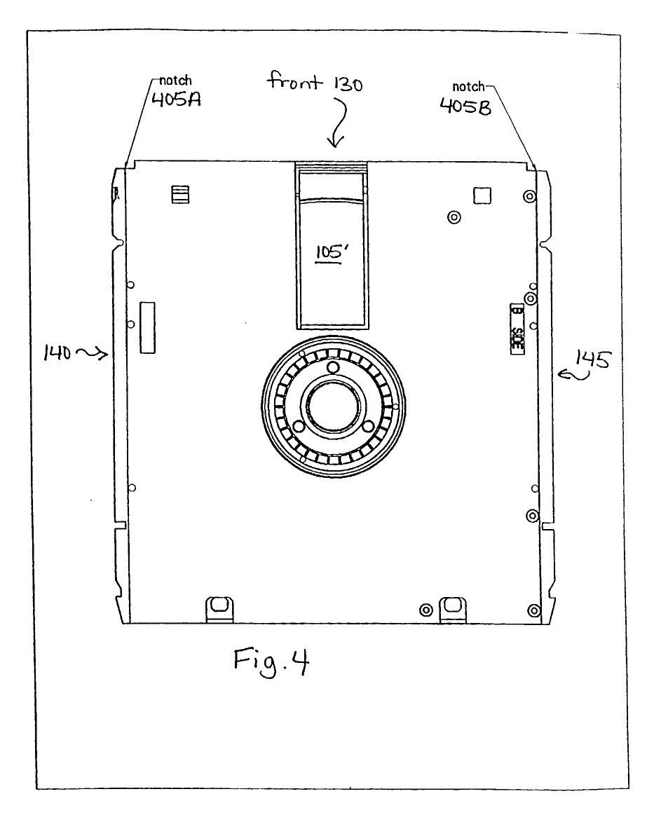

FIG. 4 shows the present invention's addition of “media identification” notches 405 in the cartridge 400. These notches are created at the front face of the cartridge 400. As is shown in FIG. 4, each notch causes removal of a portion of the front-most area of the left side 140A and right side 140B of the cartridge 400. In other words, to the front corners of the cartridge are removed. In this manner, the cartridge 100 shown in FIG. 4 is of the same physical size and overall shape as those cartridges of previous systems (as shown in FIG. 1). Importantly, the optical disk 105′ of FIG. 4 is of a different capacity from that of the disk shown in FIG. 1. Therefore, it is known as a new generation (in comparison to older, previous generations). While the overall look of the cartridges 100 remain fairly the same, the internal optical disk 105′ can vary greatly from one generation to the next.

The addition of the notches 405A and 405B to the disk cartridge 100 allows for backward compatibility in the optical disk industry. When a user places an older disk cartridge 100 into an older drive, the full-insert detection switches cause the disk to spin-up and then the drive unit can successfully access data from the optical disk. However, since the older drive unit may damage the new generation of optical disks, when such a new cartridge shown in FIG. 4 is inserted into an older drive unit, the notches 405A and 405B prevent the full-insert detection switches from actuating and thus prevents the drive unit from even spinning-up the optical disk. Thus, even if a user wrongly inserts a new generation disk cartridge into a previous generation drive unit, no damage will occur to the cartridge or the optical disk 105′.

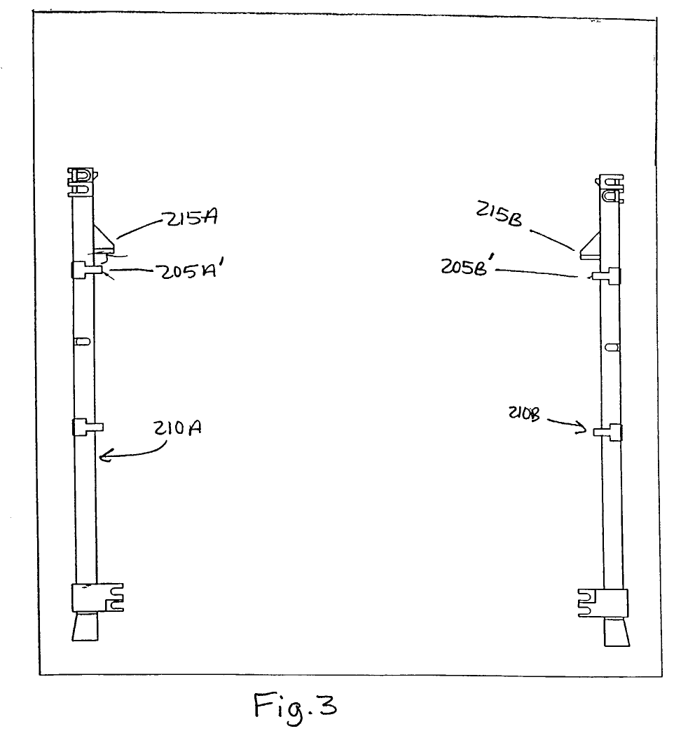

The present invention also offers an improvement to the new generation of drive units, allowing for backward compatibility. Referring to FIG. 3, a left and right cartridge holder (210A and 210B) are illustrated. However, in this new generation of disk drive unit, the full-insert detection switches 205A′ and 205B′ have been repositioned. They are now found further away from the stop-guides 215A and 215B, in such a way that when a new generation disk cartridge is inserted into the new generation disk drive unit, the full-insert detection switches are activated by the presence of the sides of the disk cartridge 100 since the switches are no longer near the notches of the cartridge 405A and 405B. Thus, the drive unit will spin-up the disk upon insertion and the optical disk can then be accessed.

The configuration of the present invention provides backward compatibility because when a previous generation disk cartridge is inserted into a new generation drive unit, the left and right sides of the cartridge still activate the full-insert detection switches found in the cartridge holders 210A and 210B. The new generation drive units are configured to access both new generation formats and previous generation formats of data as stored on the various optical disks 105 and 105′. This allows a consumer to upgrade to a new generation drive unit and still be able to use their optical disks from a previous generation.

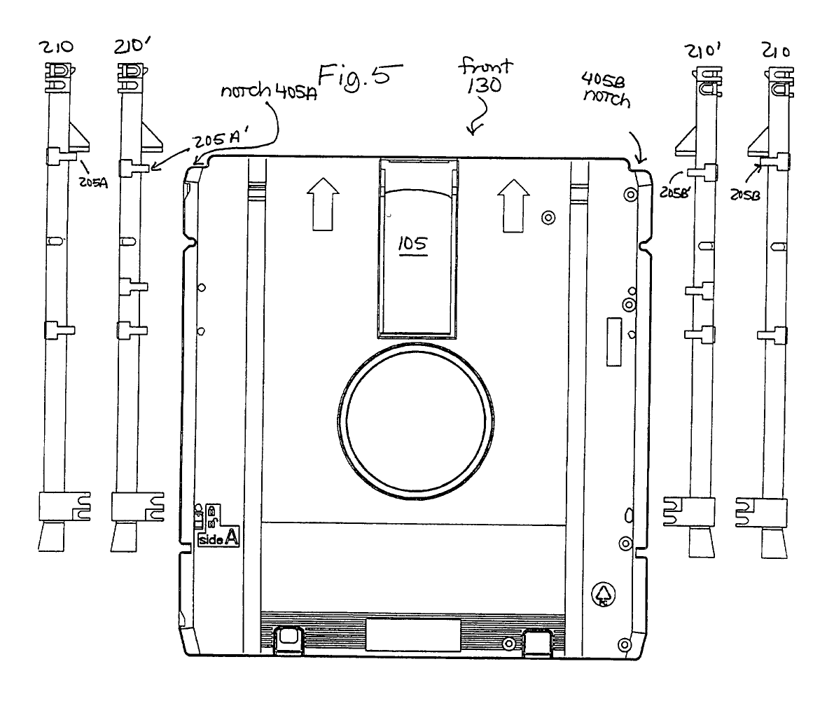

For comparison purposes, FIG. 5 presents a new generation cartridge 100 (having notches 405A and 405B) in relation to a set of new generation cartridge holders 210′ as well as the previous generation cartridge holders 210. This allows the reader to visually compare the different positioning of the full-insert detection switches 205 and 205′ and to visualize how these switches interact with the notches 405 of the new generation disks.

The foregoing description addresses embodiments encompassing the principles of the present invention. The embodiments may be changed, modified and/or implemented using various types of arrangements. Those skilled in the art will readily recognize various modifications and changes that may be made to the invention without strictly following the exemplary embodiments and applications illustrated and described herein, and without departing from the scope of the invention, which is set forth in the following claims.

What is claimed is:

1. An optical disk cartridge, comprising
a housing having a substantially rectangular shape;
an optical disk located within the housing;
a first notch along a first corner edge of the housing;
a second notch along a second corner edge of the housing;
said housing configured for insertion into a cartridge holder of a first disk drive unit until the cartridge is opposed by a first guide-stop; and
said first and second notches positioned to interact with a first identification sensor when the housing is positioned adjacent to the first guide-stop such that the housing restricts the first identification sensor detecting the housing.

2. The optical disk cartridge from claim 1, wherein the first and second notches are also positioned on the housing such that insertion of the housing into a second disk drive unit until the housing opposes a second guide-stop causes a second identification sensor to detect the housing.

3. The optical disk cartridge of claim 1, wherein the first disk drive unit does not spin up the optical disk when the housing is inserted.

4. The optical disk cartridge of claim 1, wherein the second disk drive unit spins up the optical disk when the first identification sensor detects the housing.

5. A cartridge insertion assembly for an optical disk drive unit for detecting the insertion of a first or a second optical disk cartridge, the assembly comprising:
an identification sensor proximate to a cartridge holder and not proximate to a guide-stop within the optical disk drive unit; wherein the identification sensor interacts with the first or second optical disk cartridge when inserted within the disk drive;
wherein the first and the second optical disk cartridges each has a substantially rectangular shape;
wherein the second optical disk cartridge further comprises a first and second notch, to identify the type of the optical disk media within the second optical disk cartridge;
wherein the first notch is formed along a first corner and the second notch is formed along a second corner; and
wherein the first optical disk drive cartridge does not further comprise a third notch nor a fourth notch comparable in location to the first and second notches of the second optical disk cartridge.

6. The cartridge insertion assembly from claim 5 wherein the first optical disk cartridge contains a first optical disk formatted in a first format and the second optical disk cartridge contains a second optical disk formatted in a second format.

7. An optical disk drive system, comprising:
an optical disk cartridge, comprising
a cartridge housing having a substantially rectangular shape;
an optical disk located within the housing;
a first notch along a first corner edge of the cartridge housing
a second notch along a second corner edge of the cartridge housing; and
an optical disk drive unit, comprising:
a disk drive housing;
a cartridge holder within the housing;
a guide-stop within the housing for preventing the optical disk cartridge from being overly inserted; and
an insertion sensor proximate to the cartridge holder, and not proximate to the guide-stop, for detecting the insertion of the cartridge housing into the disk drive housing;
wherein the insertion sensor also detects the insertion into the disk drive housing of a second cartridge, the second cartridge having a second housing that does not have notches comparable to the first and second notch.
